(19) United States
(12) Patent Application Publication
(10) Pub. No.: US 2022/0255867 A1
(43) Pub. Date: Aug. 11, 2022

(54) ENABLING QUALITY OF SERVICE (QOS) IN INFORMATION CENTRIC NETWORKING (ICN)

(71) Applicant: Intel Corporation, Santa Clara, CA (US)

(72) Inventors: Gabriel Arrobo Vidal, Hillsboro, OR (US); Maria Ramirez Loaiza, Beaverton, OR (US); Zongrui Ding, Portland, OR (US); Qian Li, Beaverton, OR (US); Geng Wu, Portland, OR (US)

(21) Appl. No.: 17/442,525

(22) PCT Filed: May 1, 2020
(86) PCT No.: PCT/US2020/031048

§ 371 Date: Sep. 23, 2021

Related U.S. Application Data
(60) Provisional application No. 62/842,062, filed on May 2, 2019.
(60) Provisional application No. 62/842,077, filed on May 2, 2019.

(51) Int. Cl. H04L 47/2441; H04L 69/22; H04W 28/02

(52) U.S. Cl. CPC H04L 47/2441; H04W 28/0268; H04L 69/22

(57) ABSTRACT

Systems and methods for enabling quality-of-service (QoS) within information centric networking (ICN) networks include receiving, at a network node of an ICN network, an interest packet including a name field and a quality-of-service (QoS) field, the QoS field including at least one QoS parameter. The network node is configured to extract the at least one QoS parameter and a name from the interest packet and forward the interest packet from the network node based on both the name and the QoS parameter.

### PRIORITY CLAIM

This application claims the benefit of priority to U.S. Provisional Application Ser. No. 62/842,062, filed May 2, 2019, and to U.S. Provisional Application Ser. No. 62/842,077, filed May 2, 2019, both of which are incorporated herein by reference in their entirety.

### TECHNICAL FIELD

Embodiments described herein generally relate to information centric networking (ICN), and in particular, to enabling quality of service (QoS) in ICN networks

### BACKGROUND

Information Centric Networking (ICN) is a networking architecture that accesses content by name, which is a paradigm shift from conventional networking architecture, which is based on Internet Protocol (IP). With IP networks, communication is host-to-host and content delivery relies on sessions between two end points.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example ICN, according to an embodiment.

FIG. 2 is a block diagram illustrating example packet and data flow for a node of an ICN.

FIG. 3 is a diagram illustrating an example interest packet that includes QoS fields.

FIG. 4 is a diagram illustrating quality of service fields for an example interest packet.

FIG. 5 is a flowchart illustrating a method for processing QoS fields in ICN nodes.

FIG. 6 is a diagram illustrating an example flow of interest packets.

FIG. 7 is a block diagram illustrating a packet and context communication from an ICN network to a different network for enabling QoS.

FIGS. 8A and 8B are block diagrams illustrating systems for mapping ICN QoS to context for enabling ICN QoS in different networks.

FIG. 9 is a block diagram illustrating an example of a machine upon which one or more embodiments may be implemented.

### DETAILED DESCRIPTION

In the following description, methods, configurations, and related apparatuses are disclosed for enabling quality-of-service (QoS) in information centric networking (ICN). To enable QoS in ICN networks, QoS field(s) are added to interest packets that specify QoS parameters, such as throughput, latency, reliability, and the like. The QoS fields are processed in the ICN nodes, enabling QoS-aware caching policies, QoS-aware forwarding strategies, and QoS-aware resource demand.

It is also desirable to enable ICN QoS awareness for lower communication layers (e.g., the link layer for Wi-Fi) to interpret ICN QoS information such that the lower layer can properly handle the ICN packets from the network layer for service classification. This enables assignment of priorities, queues, and the like for ICN traffic at the link level for protocols like Wi-Fi. Additionally, the examples disclosed herein enables cellular networks to perform packet classification and provide QoS inside the cellular network for ICN packets.

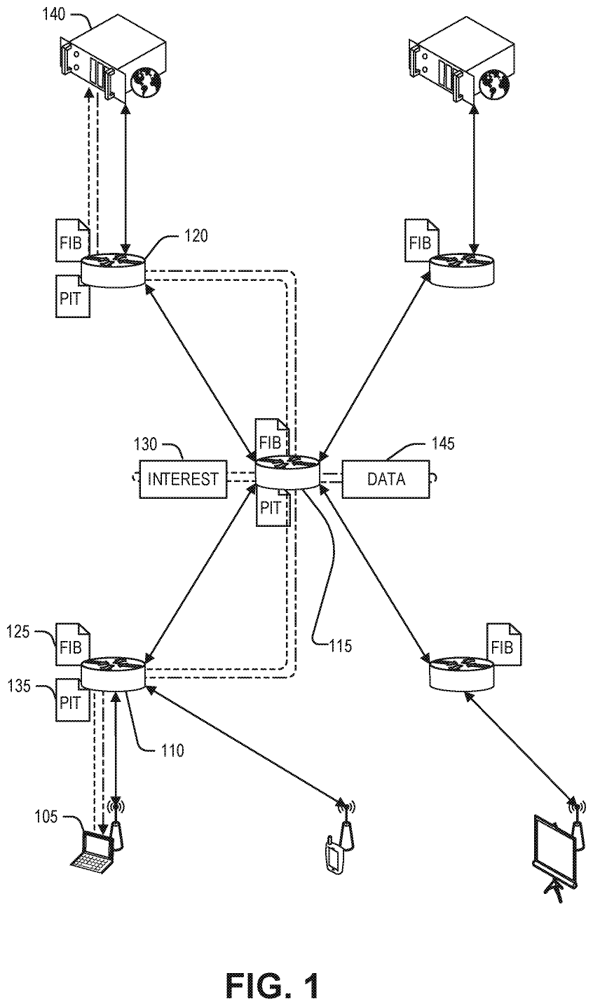

FIG. 1 illustrates an example ICN, according to an embodiment. ICNs operate differently than traditional host-based (e.g., address-based) communication networks. ICN is an umbrella term for a networking paradigm in which information or functions themselves are named and requested from the network instead of hosts (e.g., machines that provide information). In a host-based networking paradigm, such as used in the Internet protocol (IP), a device locates a host and requests content from the host. The network understands how to route (e.g., direct) packets based on the address specified in the packet. In contrast, ICN does not include a request for a particular machine and does not use addresses. Instead, to get content, a device 105 (e.g., subscriber) requests named content from the network itself. The content request may be called an interest and transmitted via an interest packet 130. As the interest packet traverses network devices (e.g., network elements, routers, switches, hubs, etc.)—such as network elements 110, 115, and 120—a record of the interest is kept, for example, in a pending interest table (PIT) at each network element. Thus, network element 110 maintains an entry in its PIT 135 for the interest packet 130, network element 115 maintains the entry in its PIT, and network element 120 maintains the entry in its PIT.

When a device, such as publisher 140, that has content matching the name in the interest packet 130 is encountered, that device 140 may send a data packet 145 in response to the interest packet 130. Typically, the data packet 145 is tracked back through the network to the source (e.g., device 105) by following the traces of the interest packet 130 left in the network element PITs. Thus, the PIT 135 at each network element establishes a trail back to the subscriber 105 for the data packet 145 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com,” a sub-category, “videos,” and the canonical identification “v8675309.” As an interest 130 traverses the ICN, ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 130 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 130 to data cached in the ICN element. Thus, for example, if the data 145 named in the interest 130 is cached in network element 115, then the network element 115 will return the data 145 to the subscriber 105 via the network element 110. However, if the data 145 is not cached at network element 115, the network element 115 routes the interest 130 on (e.g., to network element 120). To facilitate routing, the network elements may use a forwarding information base 125 (FIB) to match named data to an interface (e.g., physical port) for the route. Thus, the FIB 125 operates much like a routing table on a traditional network device.

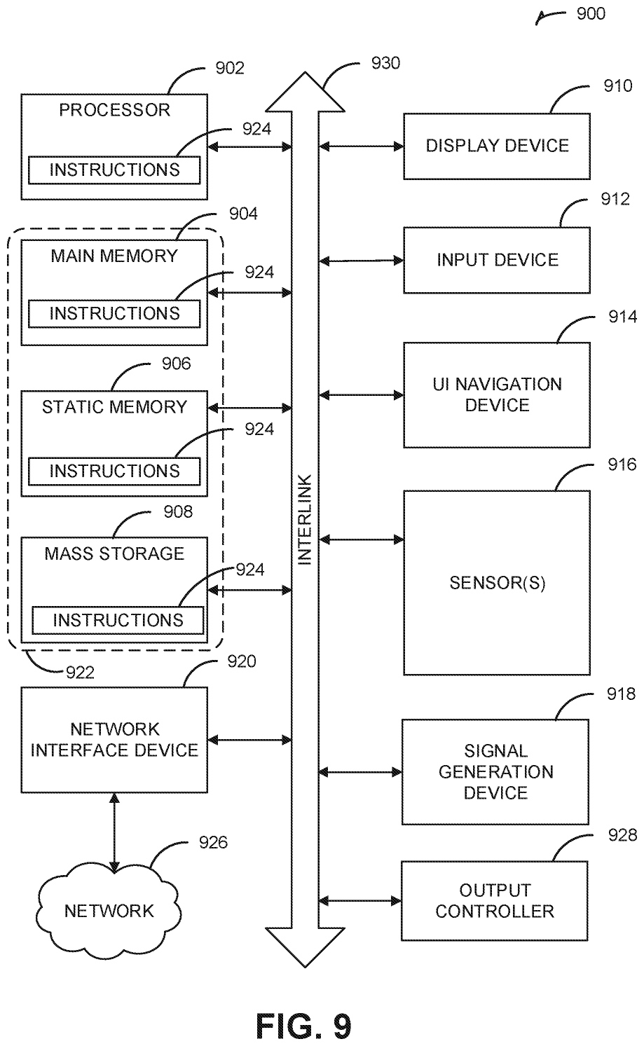

The operation of the PIT and FIB in an ICN network generally occur at a network layer above the physical (PHY) or link layers in a network. For example, the PIT and FIB operate to direct packets across physical interfaces (e.g., ports) that connect to other network devices via a link layer (e.g., data link layer) on top of a PHY layer. Thus, like traditional host-based networking, a variety of PHY layers may be used without changing the operation of the upper ICN layers. Examples of these PHY layers may be wired or wireless, and may vary across a single network. For example, the PHY connection between the network device 105 may be a cellular wireless connection in accordance with a 3GPP family of standards while the connection from the network device 110 to the network device 115 may be an optical (e.g., fiber) or electrical (e.g., conductive wire) operating in accordance with an IEEE 802.3 (Ethernet) family of standards. Other examples of wired or wireless PHY or link layer technologies that may be used are provided below with respect to FIG. 9.

In an example, additional meta-data may be attached to the interest packet 130, the cached data, or the route (e.g., in the FIB 125), to provide an additional level of matching. For example, the data name may be specified as “www.somedomain.com or videos or v8675309,” but also include a version number—or timestamp, time range, endorsement, etc. In this example, the interest packet 130 may specify the desired name, the version number, or the version range. The matching may then locate routes or cached data matching the name and perform the additional comparison of meta-data or the like to arrive at an ultimate decision as to whether data or a route matches the interest packet 130 for respectively responding to the interest packet 130 with the data packet 145 or forwarding the interest packet 130.

ICN has advantages over host-based networking because the data segments are individually named. This enables aggressive caching throughout the network as a network element may provide a data packet 130 in response to an interest 130 as easily as an original author 140. Accordingly, it is less likely that the same segment of the network will transmit duplicates of the same data requested by different devices.

Fine grained encryption is another feature of many ICN networks. A typical data packet 145 includes a name for the data that matches the name in the interest packet 130. Further, the data packet 145 includes the requested data and may include additional information to filter similarly named data (e.g., by creation time, expiration time, version, etc.). To address malicious entities providing false information under the same name, the data packet 145 may also encrypt its contents with a publisher key or provide a cryptographic hash of the data and the name. Thus, knowing the key (e.g., from a certificate of an expected publisher 140) enables the recipient to ascertain whether the data is from that publisher 140. This technique also facilitates the aggressive caching of the data packets 145 throughout the network because each data packet 145 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN), as specified in the Internet Engineering Task Force (IETF) draft specifications for CCNx 0.x and CCN 1.x, and named data networking (NDN), as specified in the NDN technical report DND-0001.

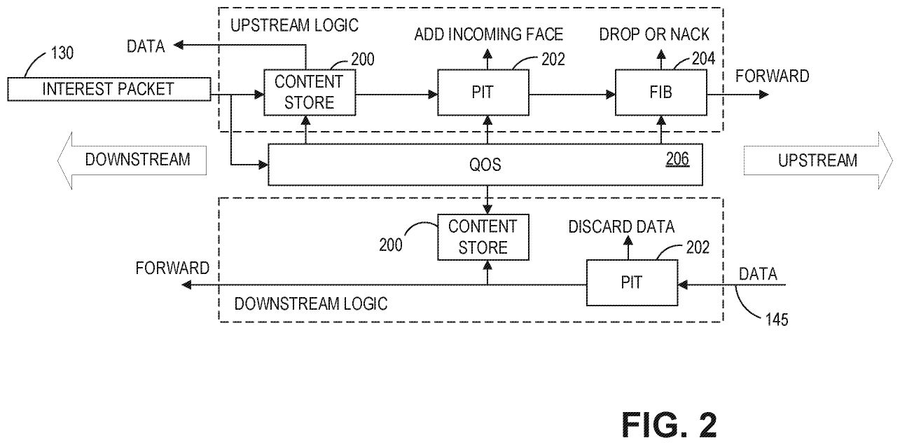

FIG. 2 is a diagram illustrating example packet and data flow for a node of an ICN network, such as any of network elements 110, 115, or 120 of FIG. 1. The node includes one or more content stores 200, one or more PITs 202, one or more FIBs 204, and QoS logic 206. In the example illustrated in FIG. 2, a data packet 145 follows a similar reverse path as its corresponding interest packet 130.

To retrieve data, when a node receives an interest packet 130, the node first checks whether the content is cached within the content store 200. If the content is not cached, the interest packet 130 is passed to the PIT 202. A name from the interest packet 130 is used to check whether the PIT 202 has an entry matching the name. If no match is found, the node records the interest in the PIT 202 and forwards the interest packet 130 toward the requested content based on information in the FIB 204.

Conventional ICN architectures do not include QoS management. Accordingly, the content within the network is all treated in a substantially similar manner. The examples disclosed herein utilize QoS field(s) added to the ICN packets to identify and implement QoS functionality at the ICN network layer.

By including QoS within ICN nodes, QoS-aware caching policies may be implemented, and currently available caching policies may be improved. QoS within ICN nodes also enables QoS-aware forwarding strategies. The QoS logic 206 may be used to implement QoS-aware caching and forwarding strategies, as discussed further below. The QoS logic 206 may be implemented in hardware or software and is configured to process the QoS field(s) from the interest packets 130 and use the QoS information to influence the operation of the PIT 202, FIB 204, and the content store 200. Moreover, because data packets 145 follow the same path, in reverse, as interest packets 130, network resources throughout the path may be reserved to better serve the data packets 145 using QoS. Additionally, neighboring ICN nodes may provide feedback to respective nodes that forwarded an interest packet 130 indicating whether the node has enough resources to route the respective interest packet 130.

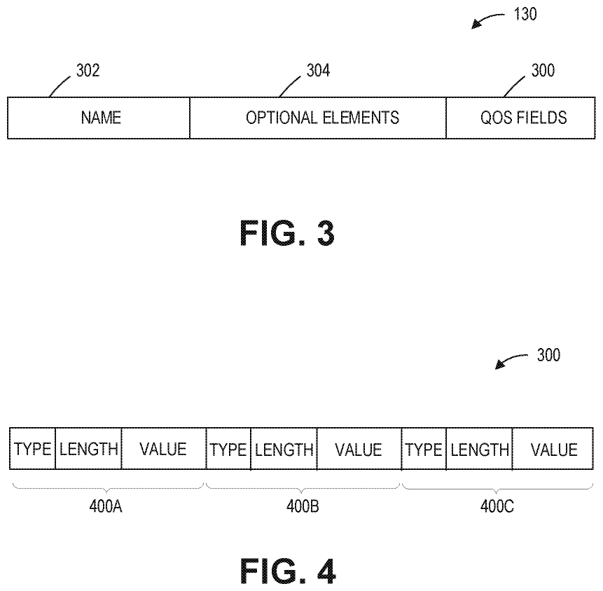

FIG. 3 is a diagram illustrating an example interest packet 130 that includes QoS fields 300. The interest packet 130 includes the QoS fields 300, a name field 302 and an optional elements field 304. The name field 302 includes the name of the interest and the optional elements fields 304 can include various optional ICN parameters including CanBePrefix (allowing a name in an interest packet to be a prefix, exact, or full name), MustBeFresh (indicating that cached data must not be stale), ForwardingHint (providing a list of name delegations), Nonce (allowing unique identification of interest packets), InterestLifetime (indicating a time before the interest times out), HopLimit (indicating a number of hops the interest is allowed to be forwarded), ApplicationParameters (arbitrary data parameters), and the like. The QoS fields 300 may include one or more values corresponding to one or more QoS metrics such as throughput, latency, reliability, and the like.

In an example, the ICN packets (e.g., interest packet 130) may include type-length-value (TLV) fields for the QoS fields 300. An advantage of using TLV fields is that if an ICN node does not understand a QoS field(s), the TLV field can be skipped. Thus, if an ICN node does not understand the QoS field(s), the node will continue reading the rest of the interest packet 130 without generating an error. Furthermore, by using TLV fields, no changes are needed for the PIT 202 with respect to conventional ICN networks.

FIG. 4 illustrates example QoS fields 300 of an interest packet 130. In FIG. 4, the example QoS fields 300 include three TLV fields 400A, 400B, and 400C. In an example, each field 400A, 400B, and 400C may correspond to an application metric, such as throughput, latency, and reliability. In an example, the value for TLV field 400A may be given in megabits per second (Mbps) for throughput, the value for TLV field 400B may be given in milliseconds (ms) for latency, and the value for TLV field 400C may be given as a percentage of packets lost for reliability. In another example, the TLV values may be provided as a dimensionless priority number indicative of a priority for a QoS metric, such as throughput, latency, reliability, and the like.

In some examples, QoS may be provided based on which TLV fields are present. For example, or each ICN packet, one or more of the TLV fields 400A-400C may not be present. In this example, the length field may be zero for TLV fields (400A-400C) for respective QoS parameters that are present as the node will know which field is present based on the type field. For example, TLV field 400A may have a type that indicates throughput, TLV field 400B may have a type that indicates latency, and TLV field 400C may have a type that indicates reliability. If an application is latency sensitive, only TLV field 400B is present and has a length of 0 (e.g., no value field is needed).

In another example, only one TLV field 400A may be used for all QoS parameters. For example, a four-byte encoding may be used to express a QoS parameter as the TLV-value may be up to 255 bytes. A conversion or mapping, as shown in Table 1, may be executed to convert from an application metric to a QoS parameter value, and vice versa. An application may specify threshold, latency, and reliability values, and a function f (Threshold, Latency, Reliability) may be used to generate the TLV-value for the single TLV field 400A.

TABLE 1
Example map/conversion from an application to ICN QoS

| | | | QoS (TLV-value) |
|---|---|---|---|
| | | | (e.g., 4-byte |
| Throughput | Latency | Reliability | representation) |
| Thr₁ | Lat₁ | Rel₁ | f (Thr₁, Lat₁, Rel₁) |
| Thr₂ | Lat₂ | Rel₂ | f (Thr₂, Lat₂, Rel₂) |
| . . . | . . . | . . . | . . . |
| Th_{N} | Lat_{N} | Rel_{N} | f (Thr_{N}, Lat_{N}, Rel_{N}) |

In another example, only one TLV field 400A may be used for all QoS parameters. In this example, rather than using a conversion as illustrated in Table 1, each metric may be assigned a given number of bytes for a respective representation within the TLV value field such that the sum of all values assigned (byte length) to the QoS metrics is equal to the TLV-length.

An application, such as an application running on the device 105, may generate and add the QoS values to the interest packets 130 as the application knows the type of content being consumed and the content requirements (e.g., a Voice-over IP (VoIP) application may prioritize latency). ICN nodes/routers, such as devices 110, 115, and 120, use the information from the QoS field(s) of the interest packets 130 to provide an appropriate QoS within the node using the QoS logic 206.

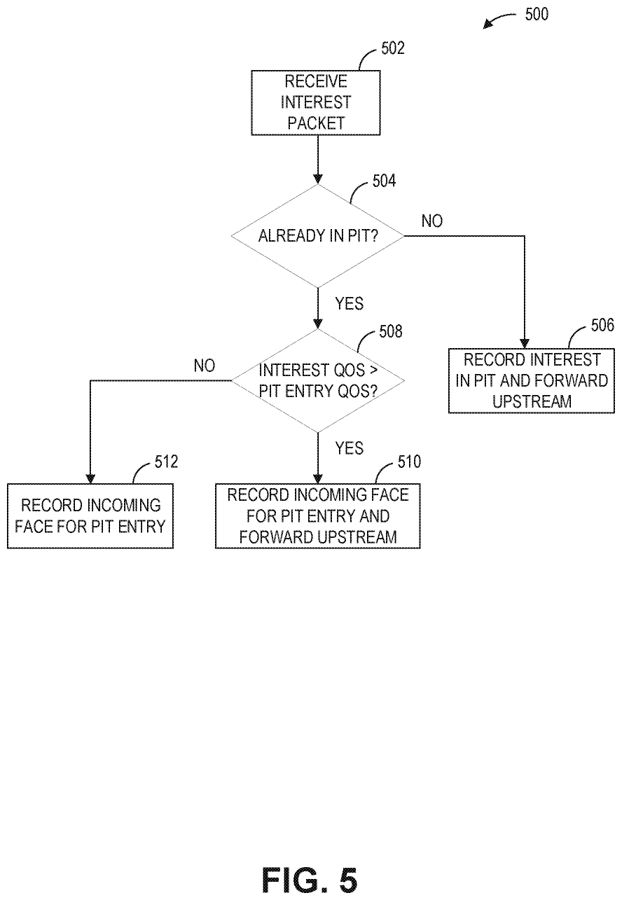

FIG. 5 is a flowchart illustrating a method 500 of processing QoS field(s) in ICN nodes or routers. At step 502, an interest packet 130 is received at a node and the name and QoS parameters are extracted from the interest packet 130. At step 504, using the name from the interest packet 130, the node checks the PIT 202 to determine if the interest has previously been received. If the name is not already in the PIT 202, the node adds the interest, including the QoS, to the PIT 202 and forwards the interest packet 130 upstream (step 506).

If the PIT 202 already includes the interest, the node compares the QoS from the received interest packet 130 to the stored QoS for the respective interest (step 508). If the newly received interest has a higher QoS than a previously received interest having the same name, the entry for the respective interest is updated in the PIT 202 with the QoS information and interface of the newly received interest packet 130 (step 510). Additionally, the interest packet 130 is passed to the FIB 204 to be forwarded upstream based on the forwarding strategy for the given QoS of the interest packet 130. If there is already an entry in the PIT 202 that has the same name as the newly received interest packet 130 and the newly received interest packet 130 has equal or lower QoS parameters as the entry already in the PIT 202, the incoming interface gets recorded in the PIT 202 and the interest packet 130 is not forwarded upstream (step 512).

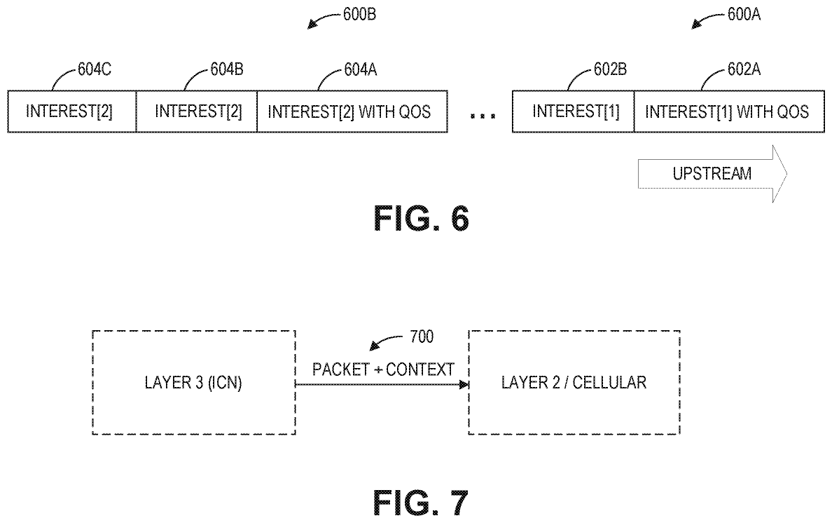

FIG. 6 is a diagram illustrating an example flow of interest packets, such as from one or more applications executing on the device 105. Typically, interest packets 130 are created in sequence. Therefore, including the QoS field(s) in only the first packet of the stream may be sufficient. In some examples, after a series of interests (for the same application/name) are transmitted, the QoS field(s) may once again be added to a subsequent interest packet to reassure the QoS that is being requested by the application at the device 105, or modify the QoS requirements of subsequent interest packets.

Adding QoS fields to only the first interest packet also reduces the overhead introduced by ICN QoS. In the example illustrated in FIG. 6, first content is requested with two interest packets 602A and 602B, and second content is requested with three interest packets 604A, 604B, and 604C. In this example, QoS field(s) may only be added to the first transmitted packet 602A and 604A for each respective requested content. Subsequent interest packets 602B, and 604B and 604C do not include the QoS field(s). In this example, ICN nodes may use the name from the interest packets for packets 602B, 604B, and 604C to infer the QoS based on the previously received interest packets 602A and 604A, such as by using the QoS parameters stored in the PIT 202 or FIB 204.

In some examples, QoS field(s) may be added to the first interest packet and, based on a counter or timer, QoS fields may be added to subsequent interest packets in each stream. For example, the first interest packet (e.g., 602A) may include the QoS fields. After a threshold amount of time, number of packets, or other value, QoS fields may be added to a subsequent packet. This may be desirable to “refresh” the QoS values for a given stream in case the application has adjusted priorities since the first interest packet was sent.

When an application inserts QoS field(s) in some but not all packets (e.g., the first packet 600A), a forwarder in the node may track the QoS field(s) previously transmitted for that respective stream of packets. Because the forwarder may send an interest packet with QoS through one interface and another interest packet (from the same stream) without QoS through another interface, the forwarder may insert the QoS fields in the interest packet before forwarding the interest packet upstream.

QoS may also be used to create new caching policies or upgrade existing caching policies for node devices, such as devices 110, 115, and 120. In these examples, caching policies may consider the information from the QoS field(s) 300 ICN packets. Conventional caching policies in ICN nodes may include, for example, least recently used (LRU), first-in-first-out (FIFO), least frequently used (LFU), random, and the like. These caching policies may be extended with other parameters to make more advanced policies such as lifetime tracking (evaluating how long entries stay in the cache), content freshness (cache data only for the time indicated in a FreshnessPeriod (defining how long a node should wait after arrival of the data before marking the data as “not fresh”) field of data packets 145), probabilistic (based on a probability that data is stored in the cache). Other caching policies may also be used including low inter-reference recency set (LIRS), adaptive replacement cache (ARC), clock with adaptive replacement (CAR), multi queue (MQ), and the like. QoS may be considered to implement QoS-aware caching policies to extend these node caching policies into more sophisticated caching policies.

In an example, a QoS-aware freshness set of policies may be implemented. For a QoS-aware freshness caching policy, the FreshnessPeriod field may have a higher precedence than the QoS field(s). That is, if the content is considered “fresh” in the cache, QoS field(s) may influence the replacement policy. After the freshness period expires, the content is considered stale (e.g., non-fresh) and data may be removed from the cache with higher probability than the fresh content. A QoS-aware freshness policy may also be applied to non-fresh content and may influence what non-fresh content may be removed first.

ICN nodes may also employ QoS-aware forwarding strategies. An ICN forwarding strategy decides whether, when, and where to forward an interest packet 130 upon receipt. Interest packets 130 under a same name may be handled by the same strategy within a node (e.g., node 110), and the same interest may be handled by the same or different strategies in different nodes (e.g., nodes 115 and 120). Some forwarding strategies used by ICN nodes include best route strategy (forwards an interest to the upstream node with the lowest routing cost), multicast strategy (forwards every interest to every upstream node indicated by a supplied FIB entry), NCC Strategy, access router strategy (designed for local site prefix on an access/edge router that multicasts the first interest to every upstream node and when the data comes back, the node remembers the upstream node from which the data came), adaptive smoothed round trip time (SRTT)-based forwarding (ASF) strategy (forwards interests to the upstream node with the lowest SRTT and periodically probes other upstream sources), self-learning strategy (first broadcasts interest to learn a single path towards data, then unicasts subsequent interests along the learned path), and the like.

QoS forwarding strategies may include a QoS-aware forwarding strategy (QoS-FS), QoS-dependent forwarding strategy selection, dynamic selection of a forwarding strategy based on the QoS information, and the like. A QoS-aware forwarding strategy, which may be based on the QoS information/field(s) 300, may execute certain or all triggers (After Receive Interest, After Content Store Hit, After Receive Data, Before Satisfy Interest, Before Expire Interest, After Receive Nack) and take appropriate actions (Send Data and Send Nack). For example, after an interest packet 130 is received, the After Receive Interest Trigger immediately or after some time (depending on a timer) may invoke the Send Interest Action.

QoS-dependent forwarding strategy selection may use the QoS information/field(s) 300 to select a most appropriate forwarding strategy of currently available strategies for a node such as best route, multicast, NCC, access router, ASF, self-learning, QoS-FS, PSO-FIB, and the like to forward interest packets 130 upstream.

Dynamic selection of a forwarding strategy based on the QoS information may be similar to the QoS-dependent forwarding strategy selection. In the dynamic selection forwarding strategy, the upstream is continuously monitored to see whether a given forwarding strategy is effective in retrieving data/content and, based on measurements that are continuously stored in the content store 200, may make the decision to change a forwarding strategy.

Nodes may also use QoS to assign resources for respective streams. In an example, the node includes a short-term memory system that tracks QoS values and resource demands for respective streams. The memory system may be consulted by the node to determine the previous QoS value for a respective stream and the value may be updated when new packets are received. This may be seen as a function that given a QoS requirement, and the current status of the node (congestion, available memory, etc.) returns an adjusted QoS value that better serves the ICN packet flow in a node under the current status, while keeping an appropriate level of fairness to serve interest and data packets 130 and 145 for different names.

The adjusted QoS function may be implemented as a simple mapping of QoS values and system status values to a multiplier (e.g., high QoS, high demand maps to qos1, high QoS low demand maps to qos2, low QoS high demand maps to qos3, etc.). The adjusted QoS function may also be implemented as an intelligent system with the following components: a model that determines demand of the interest, a model that determines node near future load (availability of resources), a function that produces a new adjusted QoS value based on demand and load predicted by the models, and the like. The demand and interest models may be implemented as lookup tables learned or designed offline or may be implemented as machine learning models specially trained to predict demand and load given the interest, and status of the network.

When two streams have a same priority, the system may take several approaches such as alternating priorities giving equal share to both streams, upgrading one priority to break the tie, giving higher priority to the stream that historically requires more resources, and the like.

Enabling ICN QoS in Different Networks

In addition to implementing QoS within an ICN network at the network layer, it is desirable to enable ICN QoS for various lower communication layers, such as link layer, media access control (MAC) layer, or PHY layer among others. Currently, some communication techniques, such as Ethernet, Wi-Fi, and the like, use the Type of Service (ToS)/Traffic Class (TC) field from the Internet Protocol (IP) packet header for packet classification and Quality of Service (QoS) at the link layer. Cellular networks, such as fourth generation (4G)/long term evolution (LTE), fifth generation new radio (50/NR), and the like, generally use more parameters from the IP packet header (e.g., source IP address, destination IP address, source port, destination port, protocol ID, ToS/TC field, and the like) to classify the IP flows and provide QoS inside the cellular network. Conventionally, communication devices at layer two and cellular networks cannot make any packet classification or provide any QoS for ICN traffic.

To address these issues, ICN QoS awareness is conveyed to lower layers (e.g., layer 2) to interpret ICN QoS (e.g., layer 3) information such that the link layer may properly handle ICN packets (e.g., network layer) for service classification. This may include assigning priorities, queues, and the like for ICN traffic at the link level. Additionally, this technique enables cellular networks to perform packet classification and provide QoS inside the cellular network.

Conventionally, layer 2 devices use the ToS/TC (DSCP/DS) field from the IP packets to classify IP packets at the link layer. For cellular networks, packet filtering/traffic classification may be done using traffic flow templates (TFTs), which typically use parameters from the IP packet header. The examples described herein maps the ICN QoS values into the already pre-defined layer 2 priorities, queues, etc. Further, new packet filters (TFTs) may be used to classify ICN packets in cellular networks.

For IP-based networks, layer 2 reads the IP packet header to properly classify the packets into queues, priorities, etc. Thus, a layer 2 device (e.g., Wi-Fi station, Ethernet card, etc.) reads the first 4 bits of the header that represent the version of the IP packet—which may be 4 for IPv4 or 6 for IPv6)—and, based on the IP version, reads the DSCP field from the IPv4 header or the DS field from the IPv6 header.

Based on the information provided in the DSCP or DS fields, layer 2 classifies the IP packets accordingly. For example, Ethernet devices (with VLANs) use IEEE 802.1p to map the DSCP field from IP packets to priorities in Ethernet frames.

In Cellular networks, such as LTE, operators define one or more policies (e.g., QoS rules) and QoS is provided based on, primarily, a QoS Class Identifier (QCI) and an Allocation and Retention Policy (ARP). The QCI indicates the performance characteristics of Service Data Flow (SDF) and Evolved Packet System (EPS) bearers. IP flows are filtered through Traffic Flow Templates (TFTs) and each TFT includes one or more packet filters, where each packet filter has a unique identifier. A packet filter typically uses a 5-Tuple to classify the IP traffic or flows. A 5-tuple includes a source IP address, a destination IP address, a source port, a destination port, and a protocol ID (e.g., a protocol above IP, such as TCP, UDP, etc.). The TFT may be extended to also include QoS in IPv4 or TC in IPv6 and other fields/information.

In downlink, IP traffic coming from the public data network (PDN) is filtered through TFTs and the TFTs are mapped into different SDFs. After that, SDFs are mapped into EPS bearers at the packet data network gateway (P-GW), through which traffic is forwarded to user equipment (UE). In uplink, IP traffic created at an application layer in the UE is filtered using TFTs, mapped into EPS bearers, and sent to the P-GW. At the P-GW, EPS bearers are mapped into different SDF using TFTs.

In 5G cellular networks, the QoS model is based on QoS flows and the QoS flow is the finest granularity of QoS differentiation in a PDU session. QoS flows are mapped in the Access Network (AN) to Data Radio Bearers (DRBs) and packets are classified and marked using QoS Flow Identifiers (QFIs) within a PDU session. Non-Access Stratum (NAS) level packet filters in the UE and in the 5GC (User Plane Function, UPF) associate uplink (UL) and downlink (DL) packets with QoS Flows and at Access Stratum (AS) level, mapping rules in the UE and NG-RAN (gNB) associate UL and DL QoS Flows with DRBs.

For downlink traffic, the UPF maps User Plane traffic to QoS flows based on the Packet Detection Rules (PDRs) and for uplink traffic, the UE uses the stored QoS rules to determine mapping between UL User Plane traffic and QoS Flows. These QoS rules may be explicitly provided to the UE during PDU Session Establishment or Modification procedures, pre-configured in the UE or implicitly derived by the UE by applying Reflective QoS.

A Packet Filter Set is used in the QoS rule and the PDR to identify one or more packet (IP or Ethernet) flow(s). A Packet Filter Set may contain one or more packet filters. For IP flows, a packet filter may be based on a source/destination IP address or IPv6 prefix, source or destination port number, protocol ID of the protocol above IP or Next header type, type of Service (TOS) (IPv4) or Traffic class (IPv6) and Mask, flow Label (IPv6), security parameter index, or packet Filter direction.

In an example, a QoS flow may be either GBR or Non-GBR depending on its QoS profile. For each QoS flow, the QoS profile may include a 5G QoS Identifier (5QI) and an ARP. The 5G QoS Identifier may be a scalar that is used as a reference to a specific QoS forwarding behavior. Table 5 shows the standardized 5QI (including default priority level) and example services.

FIG. 7 is a block diagram illustrating conversion from a network ICN packet to a lower layer (e.g., link layer) for transmission according to a respective protocol. For example, the ICN QoS information, as described above, may be translated into information that layer 2 (e.g., Ethernet, Wi-Fi, etc.) and cellular networks (e.g., 4G and 5G) understand. For this, as shown in FIG. 7, in addition to sending the packet data to layer 2 (L2) and cellular networks, the ICN layer (Layer 3) provides context information 700 for how the packet should be treated in layer 2 and cellular networks. The context information 700 may include a value (e.g., priority, queue, or packet filter representation) that is computed based on ICN QoS parameters, ICN name, or other layer 3 parameters. For example, the context 700 may be represented as a priority value for the Ethernet device (e.g., with VLANs) to give the proper priority (e.g., in accordance with IEEE 802.1p) when sending the packet over the wired channel.

In an example, in a Wi-Fi device (e.g., station or access point) the ICN node knows the QoS parameters associated with a given packet or stream and, after computing the QoS value in the network layer, the node may use that QoS value to translate or map into one of the four Wi-Fi queues. The QoS value is sent as context information 700 to the Wi-Fi device and the context indicates the Access Category to be used to enqueue the ICN packet before it is transmitted over the wireless channel. Table 2 depicts a function that, given application metrics, translates into a QoS value. Similarly, once an ICN QoS value has been defined, an equivalent standardized value may be used in a target system (e.g., L2 priority/queue mapping).

TABLE 2
Example of ICN QoS mapping into Wi-Fi queues (802.11e/WMM)

| QoS | QoS | QoS | | |
|---|---|---|---|---|
| Parameter 1 | Parameter 2 | Parameter 3 | | “Context” |
| (e.g. | (e.g. | (e.g. | | for Wi-Fi |
| Throughput) | Latency) | Reliability) | QoS Value | System |
| Thr₁ | Lat₁ | Rel₁ | f (Thr₁, Lat₁, | AC_BE |
| | | | Rel₁) | |
| Thr₂ | Lat₂ | Rel₂ | f (Thr₂, Lat₂, | AC_VO |
| | | | Rel₂) | |
| Thr₃ | Lat₃ | Rel₃ | f (Thr₃, Lat₃, | AC_VI |
| | | | Rel₃) | |
| . . . | . . . | . . . | . . . | . . . |
| Thr_{N} | Lat_{N} | Rel_{N} | f (Thr_{N}, Lat_{N}, | AC_BK |
| | | | Rel_{N}) | |

To provide QoS for ICN-based cellular networks (LTE or 5G), new packet filters may be used. The packet filters may be based on ICN name, ICN QoS information, or other ICN packet fields-such as interestLifetime, interestHoplimit, contentFreshness, and the like. Within the cellular network, the different packet filters may be mapped to TFTs/SDFs in 4G and QoS flows in 5G to provide QoS. Thus, the ICN context 700 may be delivered in such a way that the packet filters may be properly mapped into the standardized QCI values in 4G and 5QI values in 5G. Example packet filters for ICN are shown in Table 3. As it may be seen in “packet filter N”, a filter may be built based not necessarily on the entire ICN name but based on only a part of the name (e.g., /onlinemovie). This could be useful for network operators to provide certain level of QoS based on the service provider (e.g., OnlineMovie) regardless of the specific content to be delivered from that service provider.

TABLE 3
Example packet filters for ICN packets in cellular networks

| Packet filters | ICN context for Target System (4G/5G) |
|---|---|
| Packet filter 1 | {*, ICN QoS, *, *, *} |
| Packet filter 2 | {/onlinemovie/action/superheroBlockBuster/res1080, |
| | *, *, *, *} |
| Packet filter 3 | {/onlinemovie/action/superheroBlockBuster/res1080, |
| | ICN QoS, *, *, *} |
| Packet filter 4 | {/onlinemovie/action/superheroBlockBuster/res1080, |
| | ICN QoS, interestLifetime, interestHoplimit} |
| Packet filter 5 | {/onlinemovie/action/superheroBlockBuster/res1080, |
| | ICN QoS, contentFreshness} |
| . . . | . . . |
| Packet filter N | {/onlinemovie, *, *, *, *} |

In an example, a mapping function may be used to map the ICN context 700 into L2 QoS or QoS for cellular networks (e.g., packet filters). The mapping function may be built manually based on experimentation or may be a learned function for the system (e.g., fitting a linear function to map from ICN to the target system (e.g., Wi-Fi, cellular, etc.), or a classification function, in case of categorical priorities, that maps the two priority systems such as logistic regression).

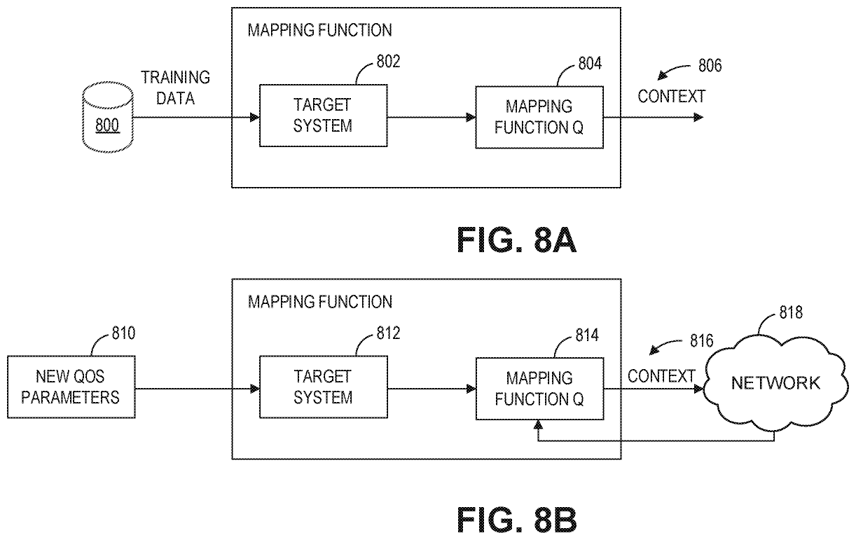

FIGS. 8A and 8B are block diagrams illustrating systems for mapping ICN QoS to context for enabling ICN QoS in different networks. FIG. 8A illustrates an offline training system that takes in training data 800 for a target system 802 to generate a mapping function 804 that maps QoS to context 806 for the target system 802. FIG. 8B illustrates an online training system that takes in new QoS parameters 810 for a target system 812 to generate a mapping function 814 to map QoS to context 816 for use on the network 818. For example, let Q for the mapping functions 804 and 814 be the function mapping QoS parameters to a context 806 or 816 (e.g., Wi-Fi). A mapping function 804 or 814 is created per context system 802 or 812 (e.g., one function for Wi-Fi, one function for Ethernet, one function for 5G (5QI), and the like). Learning the mapping function 804 offline may be done by manually designing the mapping, for example. In an example, a table, such as Table 3 above, may be manually generated for the target system 802. In another example, and as illustrated in FIG. 8A, the mapping function 804 may be learned or informed by training data 800 and experimentation.

In a controlled environment, a good mapping function 804 may be empirically learned from QoS parameters to context (e.g., Wi-Fi system) by testing QoS parameters and measuring the performance when selecting a respective context value. For example, all possible values of QoS parameters and context values may be tested and measured to determine which combination provides the best result. Once the mapping is completed, the mapping function 804 may be deployed. The mapping function 804 may be implemented as a lookup table, as a supervised classification model, such as logistic regression, naïve Bayes, or support vector machines, using the QoS parameters as inputs and best tested context value as outputs, or in any other manner.

FIG. 8B illustrates online learning of a mapping function 814. The mapping function 814 may be learned within each network 818 (e.g., cellular network) using a reinforcement learning (RL) approach where the system (e.g., a neural network) learns a good (e.g., the best) mapping between the QoS parameters and context. The RL system may observe how close the network performance is to the QoS parameters (throughput, latency, and reliability parameters) after using a context value 816 as a performance metric (e.g., loss function or reward) for the learning. This way, the mapping function 814 learns the best mapping for the network configuration and may adapt over time when the network 818 changes. In an example, an inverse distance may be used as a reward function, and an c-greedy approach may be used to learn the value function.

The preceding techniques may be implemented in any of the following scenarios:

ICN context to layer 2 (L2) for provisioning QoS: ICN context to L2 QoS (priorities/queues) that includes only ICN QoS parameters; ICN context to L2 QoS (priorities/queues) that includes only ICN name; ICN context to L2 QoS (priorities/queues) that includes ICN QoS parameters and ICN name; and ICN context to L2 QoS (priorities/queues) that includes several ICN parameters including QoS, name, interestLifetime, contentFreshness, interestHoplimit, etc.

ICN Packet filtering (QCI/5GI) in cellular networks: ICN context for packet filtering (QCI/5GI) that includes only ICN QoS parameters; ICN context for packet filtering (QCI/5GI) that includes only ICN name; ICN context for packet filtering (QCI/5GI) that includes only ICN QoS parameters and ICN name; and ICN context for packet filtering (QCI/5GI) that includes several ICN parameters including QoS, name, interestLifetime, contentFreshness, interestHoplimit, etc.

The mapping function to convert ICN parameters into “context” information: Manually build mapping based on experimentation; Learned mapping for the system—fitting a linear function to map from ICN parameters to target system (context) and classification function, in the case of categorical priorities, that maps the two priority systems such as logistic regression.

FIG. 9 illustrates a block diagram of an example machine 900 upon which any one or more of the techniques (e.g., methodologies) discussed herein may perform. Examples, as described herein, may include, or may operate by, logic or a number of components, or mechanisms in the machine 900. Circuitry (e.g., processing circuitry) is a collection of circuits implemented in tangible entities of the machine 900 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 900 follow.

In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 900 may include a hardware processor 902 (e.g., a central processing unit (CPU), a graphics processing unit (GPU), a hardware processor core, or any combination thereof), a main memory 904, a static memory (e.g., memory or storage for firmware, microcode, a basic-input-output (BIOS), unified extensible firmware interface (UEFI), etc.) 906, and mass storage 908 (e.g., hard drives, tape drives, flash storage, or other block devices) some or all of which may communicate with each other via an interlink (e.g., bus) 930. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 908, a signal generation device 918 (e.g., a speaker), a network interface device 920, and one or more sensors 916, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 902, the main memory 904, the static memory 906, or the mass storage 908 may be, or include, a machine readable medium 922 on which is stored one or more sets of data structures or instructions 924 (e.g., software) embodying or utilized by any one or more of the techniques or functions described herein. The instructions 924 may also reside, completely or at least partially, within any of registers of the processor 902, the main memory 904, the static memory 906, or the mass storage 908 during execution thereof by the machine 900. In an example, one or any combination of the hardware processor 902, the main memory 904, the static memory 906, or the mass storage 908 may constitute the machine readable media 922. While the machine readable medium 922 is illustrated as a single medium, the term “machine readable medium” may include a single medium or multiple media (e.g., a centralized or distributed database, or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 922 may be representative of the instructions 924, such as instructions 924 themselves or a format from which the instructions 924 may be derived. This format from which the instructions 924 may be derived may include source code, encoded instructions (e.g., in compressed or encrypted form), packaged instructions (e.g., split into multiple packages), or the like. The information representative of the instructions 924 in the machine readable medium 922 may be processed by processing circuitry into the instructions to implement any of the operations discussed herein. For example, deriving the instructions 924 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 924.

In an example, the derivation of the instructions 924 may include assembly, compilation, or interpretation of the information (e.g., by the processing circuitry) to create the instructions 924 from some intermediate or preprocessed format provided by the machine readable medium 922. The information, when provided in multiple parts, may be combined, unpacked, and modified to create the instructions 924. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 924 may be further transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), Information Centric Networking (ICN), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP 4G/5G wireless communication networks), Bluetooth or IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software. A transmission medium is a machine readable medium.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method comprising: receiving, at a network node of an information centric network, an interest packet comprising a name field and a quality-of-service (QoS) field, the QoS field comprising at least one QoS parameter; extracting the at least one QoS parameter and a name from the interest packet; and forwarding the interest packet from the network node based on both the name and the QoS parameter.

In Example 2, the subject matter of Example 1 optionally includes wherein forwarding the interest packet comprises: comparing the name to a plurality of stored names; and forwarding the interest packet upon determination that the name matches one of the plurality of stored names, and the QoS parameter indicates a higher priority than a stored parameter for the one of the plurality of stored names.

In Example 3, the subject matter of any one or more of Examples 1-2 optionally include wherein the interest packet is an initial interest packet, and wherein the method further comprises: receiving a subsequent interest packet with a name that matches the name of the initial interest packet; and associating, by the network node, the QoS parameter of the initial interest packet with the subsequent interest packet.

In Example 4, the subject matter of any one or more of Examples 1-3 optionally include wherein the QoS field comprises at least one type length-value (TLV) field, and wherein the QoS parameter is one of throughput, latency, or reliability.

In Example 5, the subject matter of Example 4 optionally includes wherein the QoS field comprises three TLV fields each carrying a different QoS parameter.

In Example 6, the subject matter of any one or more of Examples 4-5 optionally include wherein the QoS field comprises one TLV field encoded to carry a plurality of different QoS parameters.

In Example 7, the subject matter of any one or more of Examples 1-6 optionally include receiving, at the network node, a data packet comprising at least a name field; and caching data from the data packet based on at least one QoS parameter associated with a name from the name field of the data packet.

In Example 8, the subject matter of any one or more of Examples 1-7 optionally include wherein forwarding the interest packet comprises: generating a context based on the QoS parameter using a mapping function, the context enabling service classification for a network protocol of a communication network for transmission of the interest packet over the communication network.

In Example 9, the subject matter of Example 8 optionally includes wherein the network protocol is a protocol from an IEEE 802.11 standards family, and wherein the context comprises a priority value and queue value.

In Example 10, the subject matter of any one or more of Examples 8-9 optionally include wherein the network protocol is a cellular network protocol from a GPP standards family, and wherein the context comprises at least one packet filter.

In Example 11, the subject matter of any one or more of Examples 8-10 optionally include receiving feedback from the communication network; and updating the mapping function using the feedback.

Example 12 is a network node for use in an information centric network, the network node comprising: a content store configured to store named data; and an interest table configured to store pending interests received by the network node for named data and at least one quality of service (QoS) parameter for the pending interests; wherein the network node is configured to: receive an interest packet comprising a name field and a QoS field, the QoS field comprising at least one QoS parameter; extract the at least one QoS parameter and a name from the interest packet; and forward the interest packet based on entries within the content store for the respective name, entries in the interest table for the respective name, and the QoS parameter.

In Example 13, the subject matter of Example 12 optionally includes wherein the network node is configured to forward the interest packet by: comparing the name of the interest packet to a plurality of stored names in the interest table; and forwarding the interest packet upon determination that the name matches one of the plurality of stored names in the interest table, and the QoS parameter indicates a higher priority than a stored parameter for the one of the plurality of stored names in the interest table.

In Example 14, the subject matter of any one or more of Examples 12-13 optionally include wherein the interest packet is an initial interest packet, and wherein the network node is further configured to: receive a subsequent interest packet with a name that matches the name of the initial interest packet; and associate the QoS parameter of the initial interest with the subsequent interest packet.

In Example 15, the subject matter of any one or more of Examples 12-14 optionally include wherein the QoS field comprises at least one type length-value (TLV) field, and wherein the QoS parameter is one of throughput, latency, or reliability.

In Example 16, the subject matter of any one or more of Examples 12-15 optionally include wherein the network node is further configured to: receive a data packet comprising at least a name field; and cache data in the content store from the data packet based on at least one QoS parameter associated with a name from the name field of the data packet.

In Example 17, the subject matter of any one or more of Examples 12-16 optionally include wherein the network node is configured to forward the interest packet by: generating a context based on the QoS parameter using a mapping function, the context enabling service classification for a network protocol of a communication network for transmission of the interest packet over the communication network.

In Example 18, the subject matter of Example 17 optionally includes wherein the network node is further configured to: receive feedback from the communication network; and update the mapping function using the feedback.

Example 19 is a method comprising: generating, at a network node of an information centric network, a packet according to a protocol of the information centric network, the packet comprising at least a name and a quality-of-service (QoS) parameter; and transmitting the packet on a communication network according to a network protocol by generating a context based on the QoS parameter using a mapping function, the context enabling service classification for the network protocol for transmission of the packet over the communication network.

In Example 20, the subject matter of Example 19 optionally includes wherein the network protocol is a protocol from an IEEE 802.11 standards family, and wherein the context comprises a priority value and queue value.

In Example 21, the subject matter of any one or more of Examples 19-20 optionally include wherein the network protocol is a cellular network protocol from a GPP standards family, and wherein the context comprises at least one packet filter.

In Example 22, the subject matter of any one or more of Examples 19-21 optionally include receiving feedback from the communication network; and updating the mapping function using the feedback.

In Example 23, the subject matter of any one or more of Examples 19-22 optionally include wherein the mapping function is trained offline using training data comprising a plurality of training QoS parameters.

Example 24 is a network device of an information centric networking (ICN) network, the network device comprising: means for receiving an interest packet, the interest packet comprising a name field and a quality-of-service (QoS) field, the QoS field comprising at least one QoS parameter; means for extracting the at least one QoS parameter and a name from the interest packet; and means for forwarding the interest packet from the network node based on both the name and the QoS parameter.

In Example 25, the subject matter of Example 24 optionally includes wherein the means for forwarding the interest packet comprises: means for comparing the name to a plurality of stored names; and means for forwarding the interest packet upon determination that the name matches one of the plurality of stored names, and the QoS parameter indicates a higher priority than a stored parameter for the one of the plurality of stored names.

In Example 26, the subject matter of any one or more of Examples 24-25 optionally include wherein the interest packet is an initial interest packet, and wherein the network device further comprises: means for receiving a subsequent interest packet with a name that matches the name of the initial interest packet; and means for associating the QoS parameter of the initial interest packet with the subsequent interest packet.

In Example 27, the subject matter of any one or more of Examples 24-26 optionally include means for receiving a data packet comprising at least a name field; and means for caching data from the data packet based on at least one QoS parameter associated with a name from the name field of the data packet.

In Example 28, the subject matter of any one or more of Examples 24-27 optionally include wherein the means for forwarding the interest packet comprises: means for generating a context based on the QoS parameter using a mapping function, the context enabling service classification for a network protocol of a communication network for transmission of the interest packet over the communication network.

In Example 29, the subject matter of Example 28 optionally includes means for receiving feedback from the communication network; and means for updating the mapping function using the feedback.

Example 30 is an apparatus comprising: one or more processors and one or more computer readable media comprising instructions that, when executed by the one or more processors, cause the one or more processors to perform operations comprising: receiving an interest packet comprising a name field and a quality-of-service (QoS) field, the QoS field comprising at least one QoS parameter; extracting the at least one QoS parameter and a name from the interest packet; and forwarding the interest packet based on both the name and the QoS parameter.

In Example 31, the subject matter of Example 30 optionally includes wherein the operations of forwarding the interest packet comprise: comparing the name to a plurality of stored names; and forwarding the interest packet upon determination that the name matches one of the plurality of stored names, and the QoS parameter indicates a higher priority than a stored parameter for the one of the plurality of stored names.

In Example 32, the subject matter of any one or more of Examples 30-31 optionally include wherein the interest packet is an initial interest packet, and wherein the operations further comprise: receiving a subsequent interest packet with a name that matches the name of the initial interest packet; and associating the QoS parameter of the initial interest packet with the subsequent interest packet.

In Example 33, the subject matter of any one or more of Examples 30-32 optionally include wherein the operations further comprise: receiving a data packet comprising at least a name field; and caching data from the data packet based on at least one QoS parameter associated with a name from the name field of the data packet.

In Example 34, the subject matter of any one or more of Examples 30-33 optionally include wherein the operation of forwarding the interest packet comprises: generating a context based on the QoS parameter using a mapping function, the context enabling service classification for a network protocol of a communication network for transmission of the interest packet over the communication network.

In Example 35, the subject matter of Example 34 optionally includes wherein the operations further comprise: receiving feedback from the communication network; and updating the mapping function using the feedback.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1.-23. (canceled)

24. A method comprising:
receiving, at a network node of an information centric network, an interest packet comprising a name field and a quality-of-service (QoS) field, the QoS field comprising at least one QoS parameter;
extracting the at least one QoS parameter and a name from the interest packet; and
forwarding the interest packet from the network node based on both the name and the QoS parameter.

25. The method of claim 24, wherein forwarding the interest packet comprises:
comparing the name to a plurality of stored names; and
forwarding the interest packet upon determination that the name matches one of the plurality of stored names, and the QoS parameter indicates a higher priority than a stored parameter for the one of the plurality of stored names.

26. The method of claim 24, wherein the interest packet is an initial interest packet, and wherein the method further comprises:
receiving a subsequent interest packet with a name that matches the name of the initial interest packet; and
associating, by the network node, the QoS parameter of the initial interest packet with the subsequent interest packet.

27. The method of claim 24, wherein the QoS field comprises at least one type length-value (TLV) field, and wherein the QoS parameter is one of throughput, latency, or reliability.

28. The method of claim 27, wherein the QoS field comprises three TLV fields each carrying a different QoS parameter.

29. The method of claim 27, wherein the QoS field comprises one TLV field encoded to carry a plurality of different QoS parameters.

30. The method of claim 24, further comprising:
receiving, at the network node, a data packet comprising at least a name field; and
caching data from the data packet based on at least one QoS parameter associated with a name from the name field of the data packet.

31. The method of claim 24, wherein forwarding the interest packet comprises:
generating a context based on the QoS parameter using a mapping function, the context enabling service classification for a network protocol of a communication network for transmission of the interest packet over the communication network.

32. The method of claim 31, wherein the network protocol is a protocol from an IEEE 802.11 standards family, and wherein the context comprises a priority value and queue value.

33. The method of claim 31, wherein the network protocol is a cellular network protocol from a 3GPP standards family, and wherein the context comprises at least one packet filter.

34. The method of claim 31, further comprising:
receiving feedback from the communication network; and
updating the mapping function using the feedback.

35. A network node for use in an information centric network, the network node comprising:
a content store configured to store named data; and
an interest table configured to store pending interests received by the network node for named data and at least one quality of service (QoS) parameter for the pending interests;
wherein the network node is configured to:
receive an interest packet comprising a name field and a QoS field, the QoS field comprising at least one QoS parameter;
extract the at least one QoS parameter and a name from the interest packet; and
forward the interest packet based on entries within the content store for the respective name, entries in the interest table for the respective name, and the QoS parameter.

36. The network node of claim 35, wherein the network node is configured to forward the interest packet by:
comparing the name of the interest packet to a plurality of stored names in the interest table; and
forwarding the interest packet upon determination that the name matches one of the plurality of stored names in the interest table, and the QoS parameter indicates a higher priority than a stored parameter for the one of the plurality of stored names in the interest table.

37. The network node of claim 35, wherein the interest packet is an initial interest packet, and wherein the network node is further configured to:
receive a subsequent interest packet with a name that matches the name of the initial interest packet; and
associate the QoS parameter of the initial interest with the subsequent interest packet.

38. The network node of claim 35, wherein the QoS field comprises at least one type length-value (TLV) field, and wherein the QoS parameter is one of throughput, latency, or reliability.

39. The network node of claim 35, wherein the network node is further configured to:
receive a data packet comprising at least a name field; and
cache data in the content store from the data packet based on at least one QoS parameter associated with a name from the name field of the data packet.

40. The network node of claim 35, wherein the network node is configured to forward the interest packet by:
generating a context based on the QoS parameter using a mapping function, the context enabling service classification for a network protocol of a communication network for transmission of the interest packet over the communication network.

41. The network node of claim 40, wherein the network node is further configured to:
receive feedback from the communication network; and
update the mapping function using the feedback.

42. A method comprising:
generating, at a network node of an information centric network, a packet according to a protocol of the information centric network, the packet comprising at least a name and a quality-of-service (QoS) parameter; and
transmitting the packet on a communication network according to a network protocol by generating a context based on the QoS parameter using a mapping function, the context enabling service classification for the network protocol for transmission of the packet over the communication network.

43. The method of claim 42, wherein the network protocol is a protocol from an IEEE 802.11 standards family, and wherein the context comprises a priority value and queue value.

44. The method of claim 42, wherein the network protocol is a cellular network protocol from a 3GPP standards family, and wherein the context comprises at least one packet filter.

45. The method of claim 42, further comprising:
receiving feedback from the communication network; and
updating the mapping function using the feedback.

46. The method of claim 42, wherein the mapping function is trained offline using training data comprising a plurality of training QoS parameters.
